(19) United States
(12) Patent Application Publication
(10) Pub. No.: US 2023/0403961 A1
(43) Pub. Date: Dec. 21, 2023

(54) MULTI-PURPOSE WEEDING DEVICE

(71) Applicant: Freddie Bridges, St. Marys, GA (US)

(72) Inventor: Freddie Bridges, St. Marys, GA (US)

(21) Appl. No.: 17/844,609

(22) Filed: Jun. 20, 2022

(51) Int. Cl. A01B 1/16; B25G 1/04

(52) U.S. Cl. CPC A01B 1/16; B25G 1/04

(57) ABSTRACT

The multi-purpose weeding device allows weeding of gardens, flower beds, lawns, and other agricultural and landscaped areas from an upright standing position is presented. The device provides for a linear handle, here shown in a collapsed or retracted state. The overall length of the handle in its retracted state is approximately three feet (3 ft.) long. The upper handle segment is provided with an ergonomic hand grip, such as a rubber hand grip, with an overall approximate length of eight inches (8 in.). The lower handle segment is provided with a single tine head consisting of a ninety-degree (90°) member equipped with a pointed tine.

### FIELD OF THE INVENTION

This invention relates to weeding devices. More particularly, it relates to extendable handle weeding devices.

### BACKGROUND

A number of common weeding tools are designed to ease the task of removing weeds from gardens and lawns.

The fulcrum head weeder has a split tip like a serpent's tongue, and a long thin handle. Many models have a curved piece of metal along the handle which is put against the ground while the tip is digging. The curved metal piece acts as a fulcrum in a lever system. It is helpful to remove weeds either with a tap root or a fibrous root system.

The Cape Cod weeder has a thin, long handle and a triangular scraping head. When the handle is held parallel to the ground, the head points downward.

The crack weeder is a relative of the Cape Cod Weeder. It is designed to scrape out weeds growing in crevices, stone walls and other deep and narrow places.

The plane of the L-shaped scraping blade includes the handle; the bottom of the “L” is parallel to it.

Guna is a short traditional knife with a wide flat tip used for digging and weeding in the Philippines.

Homi is a short-handled traditional weeding and ploughing tool used by Korean People.

With the existing tools, weeding becomes difficult for people with bad backs, weak knees, or other physical disabilities due to the way the tools must be used to accomplish the task at hand.

Accordingly, and in light of the foregoing, it would be desirable to have an apparatus which allows weeding of gardens, flower beds, lawns, and other agricultural and landscaped areas from an upright standing position in a quick and effective manner.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a side view of a multi-purpose weeding device 10, equipped with a single tine head 35, according to the preferred embodiment of the present invention;

FIG. 2 is a side view of the multi-purpose weeding device 10, equipped with a double tine head 55, according to the preferred embodiment of the present invention;

FIG. 3 is a sectional view of the multi-purpose weeding device 10, as seen along a line I-I, as shown in FIG. 1, according to the preferred embodiment of the present invention;

FIG. 4 is a detailed side view of a single tine head 35, as used with the multi-purpose weeding device 10, according to the preferred embodiment of the present invention; and,

FIG. 5 is a detailed perspective view of a double tine head 55, as used with the multi-purpose weeding device 10, according to the preferred embodiment of the present invention.

### DESCRIPTIVE KEY

10 multi-purpose weeding device
15 handle
20 upper handle segment
25 ergonomic hand grip
30 lower handle segment
35 single tine head
40 ninety-degree (90°) member
45 pointed tine
50 threaded connection
55 double tine head
60 extension mechanism
65 extension travel path “e”
70 female threaded insert
75 male threaded portion
80 circular travel path “c”

### DESCRIPTION OF THE PREFERRED EMBODIMENTS

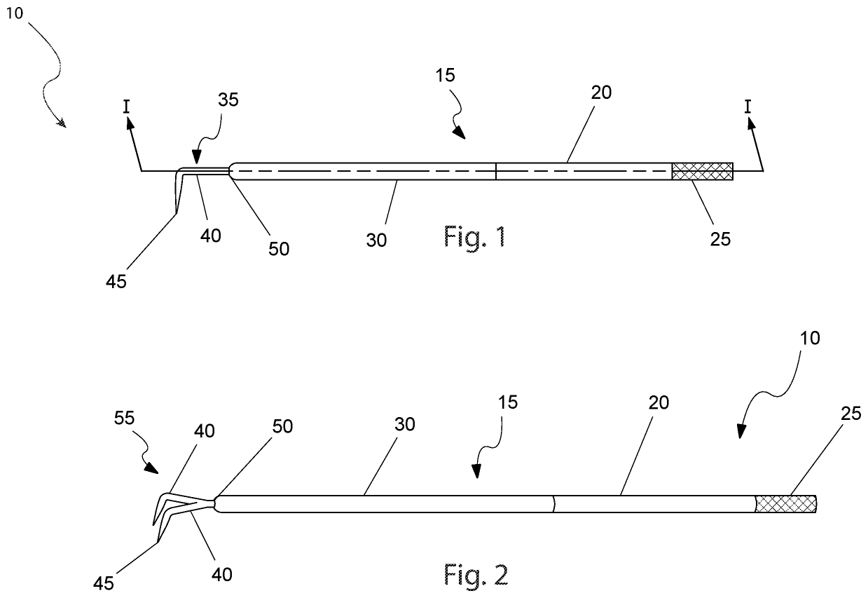

The best mode for carrying out the invention is presented in terms of its preferred embodiment, herein depicted within FIGS. 1 through 5. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one (1) particular configuration shall be shown and described for purposes of clarity and disclosure and not by way of limitation of scope. All of the implementations described below are exemplary implementations provided to enable persons skilled in the art to make or use the embodiments of the disclosure and are not intended to limit the scope of the disclosure, which is defined by the claims.

The terms “a” and “an” herein do not denote a limitation of quantity, but rather denote the presence of at least one (1) of the referenced items.

### 1. Detailed Description of the Figures

Referring now to FIG. 1, a side view of the multi-purpose weeding device 10, equipped with a single tine head 35, according to the preferred embodiment of the present invention is disclosed. The multi-purpose weeding device (herein also described as the “device”) 10, allows weeding of gardens, flower beds, lawns, and other agricultural and landscaped areas from an upright standing position. The device 10 provides for a linear handle 15, here shown in a collapsed or retracted state. The overall length of the handle 15 in its retracted state is approximately three feet (3 ft.) long. The upper handle segment 20 is provided with an ergonomic hand grip 25, such as a rubber hand grip, with an overall approximate length of eight inches (8 in.). The lower handle segment 30 is provided with a single tine head 35 consisting of a ninety-degree (90°) member 40 equipped with a pointed tine 45. The single tine head 35 is joined to the lower handle segment 30 by a threaded connection 50. Further detail on the single tine head 35 and the threaded connection 50 will be provided herein below.

Referring next to FIG. 2, a side view of the device 10, equipped with a double tine head 55, according to the preferred embodiment of the present invention is depicted. As aforementioned described, the handle 15 is comprised of the upper handle segment 20 and the lower handle segment 30. The upper handle segment 20 is equipped with the ergonomic hand grip 25. However, in contrast to FIG. 1, the handle 15 is shown in an extended state. The overall length of the handle 15 in its extended state is approximately four feet (4 ft.) long. Further description of the method of extending the handle 15 will be described in greater detail herein below. The lower handle segment 30 is provided with a double tine head consisting of two ninety-degree (90°) members 40, each equipped with a pointed tine 45. The double tine head 55 is joined to the lower handle segment 30 by the threaded connection 50. Further description of the double tine head 55 and the threaded connection 50 will be provided herein below.

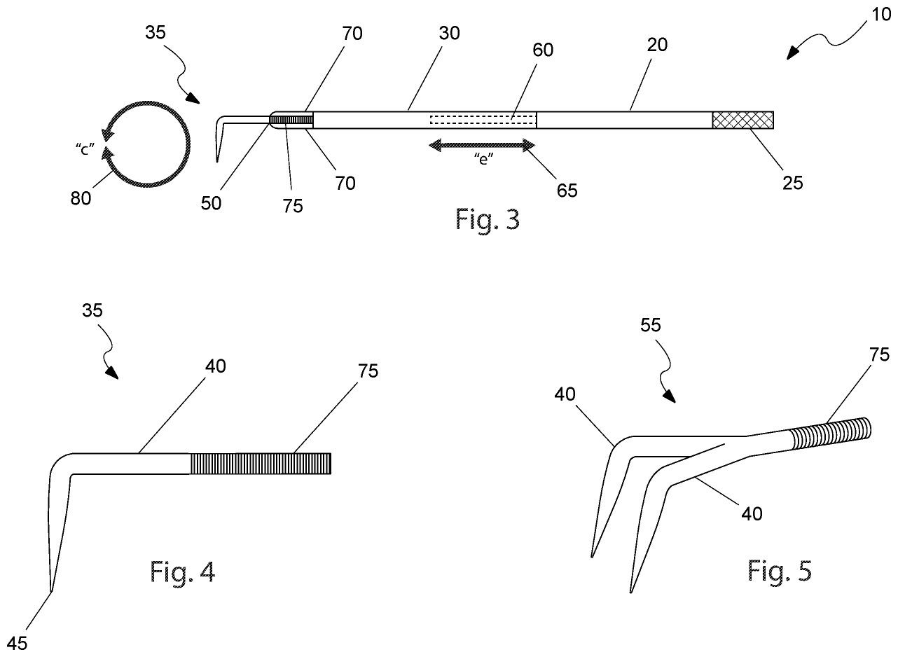

Referring now to FIG. 3, a sectional view of the device 10, as seen along a line I-I, as shown in FIG. 1, according to the preferred embodiment of the present invention is shown. The handle 15 is provided with an extension mechanism 60 on the interior of the lower handle segment 30 and encompasses by the upper handle segment 20. The extension mechanism 60 is envisioned to be a metal rod approximately three-eighths of an inch (⅜ in.) in diameter, a twist-lock-type, split collar locking-type, threaded-type, or the like. The exact method of extension utilized by the extension mechanism 60 is not intended to be a limiting factor of the present invention. When engaged, the upper handle segment 20 and the lower handle segment 30 move in relation to one another along an extension travel path “e” 65. The extension travel path “e” 65 may be varied upon factors such as size of the user, elevation of the area being worked upon, type of material being worked upon, and the like. The handle 15 is envisioned to be a female threaded insert 70 which accepts a male threaded portion 75 of the single tine head 35. The double tine head 55 (as shown in FIG. 2) will also be provide with a female threaded insert 70 that engages the extension travel path “e” The single tine head 35 is coupled and removed from the female threaded insert 70 following a male threaded portion 75.

Referring next to FIG. 4, a detailed side view of the single tine head 35, as used with the device 10, according to the preferred embodiment of the present invention is disclosed. The single tine head 35 consists of the ninety-degree (90°) member 40, the pointed tine 45, and the male threaded portion 75. The overall diameter of the single tine head 35 is envisioned to be approximately three-eighths of an inch (⅜ in.). The single tine head 35 is envisioned to be made in an extrusion and metal finishing process. After manufacture, a suitable protective finish such as paint or plating would be applied to prevent corrosion. Alternate methods of fabrication such as casting and metal finishing may also be considered.

Referring now to FIG. 5, a detailed perspective view of the double tine head 55, as used with the device 10, according to the preferred embodiment of the present invention is depicted. The double tine head 55 consists of two (2) ninety-degree (90°) members 40, two (2) pointed tines 45, and the male threaded portion 75. The overall diameter of the male threaded portion 75 as well as each of the two (2) ninety-degree (90°) members 40 is envisioned to be approximately three-eighths of an inch (⅜ in.). The double tine head 55 is envisioned to be made in an extrusion and metal finishing process. The two (2) ninety-degree (90°) members 40 may be joined to the male threaded portion 75 as part of the manufacturing process or may be welded together. After manufacture, a suitable protective finish such as paint or plating would be applied to prevent corrosion. Alternate methods of fabrication such as casting and metal finishing may also be considered.

### 2. Operation of the Preferred Embodiment

The preferred embodiment of the present invention can be utilized by the common user in a simple and effortless manner with little or no training. It is envisioned that the device 10 would be constructed in general accordance with FIG. 1 through FIG. 5. The user would procure the device 10 from conventional procurement channels such as hardware stores, home improvement stores, farm stores, mail order and internet supply houses and the like.

After procurement and prior to utilization, the device 10 would be prepared in the following manner: the user would first determine whether the single tine head 35 or the double tine head 55 would be utilized. It is envisioned that the single tine head 35 would be utilized in areas where fine control would be warranted, such as in flower bed, vegetable gardens or the like. It is envisioned that the double tine head 55 would be utilized in area where broad weed control is warranted such as lawn areas, mulched areas, and the like. The single tine head 35 or the double tine head 55 would be attached using the respective male threaded portion 75 into the female threaded insert 70 of the lower handle segment 30 following the circular travel path “c” 80 and hand tightened. Next, the overall length of the handle 15 would be adjusted by manipulating the extension mechanism 60 along the extension travel path “e” 65, until an overall satisfactory length of the handle 15 is obtained depending on the specific use of the device 10. At this point in time, the device 10 is ready for use.

During utilization of the device 10, the following procedure would be initiated: the user would hold the device 10 in their hand or hands using at least the ergonomic hand grip 25 and a portion of the upper handle segment 20 and the lower handle segment 30 in the other; the user then manipulates the device 10 such that the pointed tine 45 of either the single tine head 35 or the double tine head 55 penetrates the soil around the weed and dislodges it; this process is repeated on other additional weeds as needed.

After use of the device 10, it is stored until needed again in a cyclical manner.

The features of the device 10 provide the following benefits: ability to perform weeding from a standing position; ability adjust overall length of the device 10 to suit user or usage conditions; the ability to select either the single tine head 35 or the double tine head 55 dependent on usage conditions, the provision of the ergonomic hand grip 25 for increased usage comfort; and the reduction in pain and discomfort in the back, knee, and leg area by reducing the need to bend or kneel.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed is:

1. A multi-purpose weeding device for weeding of gardens, flower beds, lawns, and other agricultural and landscaped areas from an upright standing position, the device comprising:
a handle, the handle having an upper handle segment, an extension mechanism and a lower handle segment, the upper handle segment having a grip, the lower handle segment being female threaded end, the extension mechanism being movably coupled to the upper handle segment and the lower handle segment; and
a head, the head having a ninety-degree angle, one or more tines and a male threaded end, wherein one or more tines are coupled to the ninety-degree angle and the male threaded end is coupled to the female threaded end of the lower handle segment.

2. The device according to claim 1, wherein the handle having an extended state length of four feet.

3. The device according to claim 1, wherein the handle having a retracted state length of three feet.

4. The device according to claim 1, wherein the grip has a length of eight inches.

5. The device according to claim 1, wherein the grip is ergonomic.

6. The device according to claim 1, wherein the one or more tines is a double tine.

7. The device according to claim 1, wherein the one or more tines is a single tine head.

8. The device according to claim 1, wherein the extension mechanism is coupled to an interior of the lower handle segment.

9. The device according to claim 1, wherein the extension mechanism extends a useable length of the handle.

10. The device according to claim 1, wherein the extension mechanism retracts a useable length of the handle.

11. The device according to claim 1, wherein the extension mechanism is a rod.

12. The device according to claim 11, wherein the rod is made of a steel material.

13. The device according to claim 1, wherein the extension mechanism is three-eighths inch in diameter.

14. The device according to claim 1, wherein the extension mechanism is a twist lock type.

15. The device according to claim 1, wherein the extension mechanism is split collar locking type.

16. The device according to claim 1, wherein the extension mechanism threaded type.
